(19) United States
(12) Patent Application Publication
(10) Pub. No.: US 2026/0092002 A1
(43) Pub. Date: Apr. 2, 2026

(54) PROCESS AND APPARATUS FOR PRODUCING FLAT GLASS

(71) Applicants: Schott AG, Mainz (DE); SCHOTT Technical Glass Solutions GmbH, Jena (DE)

(72) Inventors: Volker Plapper, Mainz (DE); Georg Haselhorst, Mainz (DE); Jochen Alkemper, Mainz (DE); Tommy Schröder, Jena (DE); Michael Meister, Mainz (DE)

(73) Assignees: Schott AG, Mainz (DE); SCHOTT Technical Glass Solutions GmbH, Jena (DE)

(21) Appl. No.: 19/341,153

(22) Filed: Sep. 26, 2025

(30) Foreign Application Priority Data
Sep. 27, 2024 (DE) 10 2024 128 050.6

(51) Int. Cl. C03B 15/02; C03B 33/02; C03B 33/10

(52) U.S. Cl. CPC C03B 15/02; C03B 33/0222; C03B 33/102

(57) ABSTRACT

A process includes directing a laser beam at a glass strip so it traverses a line in a drawing direction of the horizontally moving glass strip. A point of incidence of the laser beam is chosen so the line forms an envisaged dividing line between a useful region and a thickened edge region and the point of incidence on the glass is at a position where a temperature of the glass is within a range between an upper viscosity of 10¹⁰ dPas and a lower viscosity of 10¹⁵ dPas. The laser beam photothermally processes the glass strip so a gap is formed along the line between the useful region and the thickened edge region to obtain a glass strip with a homogeneous glass thickness and a new edge parallel to the drawing direction and a separated thickened edge region. The glass strip with homogeneous thickness is cooled after separation.

### CROSS REFERENCE TO RELATED APPLICATIONS

This application claims priority to German Patent Application No. 10 2024 128 050.6 filed on Sep. 27, 2024, which is incorporated in its entirety herein by reference.

### BACKGROUND OF THE INVENTION

### 1. Field of the Invention

The invention generally relates to the manufacture of flat glass, or of articles made of flat glass, and to corresponding glass articles. In particular, the invention relates to a process and an apparatus for processing the edges of continuous endless manufactured glass strips.

### 2. Description of the Related Art

The prior art discloses various processes for producing glass strips. One option, especially for production of thin glasses, is to produce the glasses by drawing processes. A glass melt is provided here, which is pulled to a thin strip by a subsequent drawing process. The glass melt can be provided by different processes.

In the float process, for example, the glass melt is distributed over a liquid tin bath and pulled to a strip. A characteristic feature of glass strips produced in the float process is the thickened edges of the strip, also known as “borders”. The borders are caused primarily by contraction of the soft glass at the edge of the strip owing to surface tension.

A further option for production of glass strips by a drawing process is that of drawing processes such as the down-draw process or the up-draw process. The glass melt is provided here in a drawing tank with a nozzle. Even in these processes, borders can occur at the edges of the glass strip.

Processes for cooling the glass strip later on in the production process lead to occurrence of temporary stresses owing to the differences in thickness between the edge region (border) and the clear region between the borders, since the border may be temporarily longer than the strip in the region between the borders. These temporary stresses can result in a load on the glass strip and hence increase the risk of fracture. In addition, permanent stresses can occur when the glass, in the course of cooling, goes through the range of the glass transformation temperature later in the thicker border than the thinner glass in the clear region. These permanent stresses increase with further cooling and can likewise lead to an increased risk of breakage. Since the percentage difference in thickness between the thickened edge regions and the thinner useful region is greater in thin glass strips than in thicker glass strips, the difference in temperature between the border regions and the useful region is particularly pronounced. There is correspondingly a rise in the mechanical stresses in the glass strip with decreasing glass thickness. Therefore, the production of thin glass strips, especially with thicknesses<1.3 mm, is particularly susceptible to stress-induced fractures.

In addition to the glass thickness, the glass properties can also affect the buildup of tension. In particular, the cooling of glasses with a comparatively large differential between the coefficient of thermal expansion above the glass transformation temperature, α_{liq}, and the coefficient of thermal expansion in the temperature range from 20 to 300° C., α₂₀₋₃₀₀, can lead to comparatively high stress in the glass.

The stresses described above can in principle be minimized by a relatively slow cooling process. However, this is achievable in particular only with difficulty, if at all, when the glasses are rapidly crystallizable glasses. Slow cooling of the glass strip would lead here to devitrification. Therefore, these glasses have to be cooled as quickly as possible. However, a correspondingly fast cooling process can have the effect that the temperature progression in the cooling process progresses at different speeds in the regions of different glass thickness, such that the temporary stresses can subject different glass regions to different loads. These effects lead to an increased risk of fracture and can therefore increase the level of reject material in the manufacturing process. An additional factor in the case of rapidly crystallizable glasses is that the slower cooling in the border region can cause these regions to have a higher degree of crystallization than the other regions of the glass. Thus, the individual glass regions can also differ in terms of their linear coefficients of thermal expansion, as a result of which further mechanical stresses can occur in the glass strip during the processing operation or the mechanical stresses in the glass can increase further. Flat glasses with corresponding glass properties are therefore typically not provided by drawing processes, or the glasses thus produced have relatively high glass thicknesses. Thin glass strips made of glasses with a high tendency to crystallization or devitrification, on the other hand, are typically not produced by drawing processes, or not solely thereby, but provided by rolling processes for example. In contrast to the production of glass strips in drawing processes, the maximum widths of the glass strips and the minimum thickness thereof are limited in the case of production by rolling processes.

In order to reduce or to avoid the stresses resulting from the temperature regime, even in the case of rapid cooling steps, it would be helpful to separate the thick edge regions (borders) from the thin clear strip or from the useful region of the glass strip at an early stage so that stresses arising from the cooling process do not overstress the glass material and lead to potential glass fracture. Moreover, the physical separation of the differently cooling glass areas could enable even faster cooling of the glass strip according to material-specific requirements without generating excessively high temporary stresses.

WO 2015/172957 A1 discloses a process and an apparatus for production of a thin glass strip with a thickness of not more than 300 micrometres, in which the borders are removed. The thin glass strip is drawn here from a glass melt or a precursor, the borders are separated from the thin-glass strip by means of a separating apparatus, and the resulting glass strip is cooled. The separation is effected at a site in the direction of movement of the thin glass strip, or at a time when the viscosity of the glass is in the range of 10⁷ dPas to 10¹¹ dPas during the cooling of the thin glass strip, such that the edges of the thin glass strip that are newly formed are rounded by the removal of the borders. However, the process is limited to very thin glasses. For instance, usually only glasses with a glass thickness of less than 0.3 mm can be separated by the process described in WO 2015/172957 A1. The production of thin glass strips from readily crystallizable glasses is not disclosed in WO 2015/172957 A1. Moreover, in WO 2015/172957A1, this is limited to down-draw processes.

### SUMMARY OF THE INVENTION

It is an object of the invention to avoid or at least reduce the occurrence of mechanical stresses between borders and a relatively thin useful region in the production of glass strips, in particular in the production of glass strips with a glass thickness in the useful region of 0.1 to 1.3 mm, during the production process and in particular during the cooling process. The intention is additionally to provide a process by which thin glass strips of readily crystallizable glasses and/or glasses with relatively large differences in the coefficients of thermal expansion α_{liq} and α_{20-300° C.} can be produced by drawing processes. A further object is that of providing glass articles made of readily crystallizable glasses.

In some embodiments provided according to the invention, a process for producing a glass strip with homogeneous glass thickness includes: obtaining a glass strip from a melt by a drawing process, the glass strip having a useful region and thickened edge regions with respect to the useful region which extend along edges of the glass strip in a drawing direction; cooling the glass strip, wherein during the cooling, a laser beam is directed at the glass strip by at least one laser such that it traverses a line in the drawing direction of the horizontally moving glass strip owing to a movement of the glass strip, wherein a point of incidence of the laser beam is chosen such that the line forms an envisaged dividing line between the useful region and the thickened edge region and the point of incidence on the glass is at a position where a temperature of the glass is within a range between an upper viscosity of 10¹⁰ dPas and a lower viscosity of 10¹⁵ dPas, wherein the laser beam photothermally processes the glass strip in an irradiated region such that a gap is formed along the line between the useful region and the thickened edge region and a glass strip with a homogeneous glass thickness and a new edge parallel to the drawing direction and a separated thickened edge region is obtained, and wherein the cooling of the glass strip with homogeneous thickness is continued after separation. The useful region of the glass strip has a thickness of more than 0.3 mm, or the useful region of the glass strip has a thickness of more than 0.1 mm and the drawing process comprises a float process and the glass strip is lifted from a float bath, or the glass strip is subject to the following condition:

$$F B = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1$$

where α_{liq}=a linear coefficient of thermal expansion above a glass transformation temperature of the glass, α₂₀₋₃₀₀=a linear coefficient of thermal expansion of the glass at temperatures between 20° C. and 300° C., η_{liq}=a liquidus viscosity of the glass,

$$\frac{d T}{d log ( η )} ( log ( η ) = 13 ) = a$$

slope of a viscosity curve at an upper cooling point or at a temperature at which the glass has a viscosity η of 10¹³ dPas, and T₁₃=a temperature at which the glass has a viscosity η of 10¹³ dPas.

In some embodiments provided according to the invention, a glass article in the form of a flat glass, includes two opposite sides and a glass thickness d_{glass}. The glass thickness d_{glass} is at most 1.3 mm and a glass of the glass article is subject to the following condition:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 ,$$

where α_{liq}=a linear coefficient of thermal expansion above a glass transformation temperature of the glass, α₂₀₋₃₀₀=a linear coefficient of thermal expansion of the glass at temperatures between 20° C. and 300° C., η_{liq}=a liquidus viscosity of the glass,

$$\frac{d T}{d log ( η )} ( log ( η ) = 13 ) = a$$

slope of a viscosity curve at an upper cooling point or at a temperature at which the glass has a viscosity η of 10¹³ dPas, and T₁₃=a temperature at which the glass has a viscosity η of 10¹³ dPas.

In some embodiments provided according to the invention, an apparatus for producing a glass strip having homogeneous thickness from a glass strip, the glass strip having a useful region and thickened edge regions with respect to the useful region, by removing the edge regions, the apparatus includes: a drawing apparatus for producing a glass strip from a glass melt; a lehr; transport apparatuses for transporting the glass strip from the drawing apparatus into the lehr; and a laser arranged in the lehr such that a laser beam produced by the laser hits the glass strip perpendicular to a transport direction. A point of incidence of the laser is adjusted such that it is on the glass strip in an interface between the useful region and a border region.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram of one embodiment of the process in cross section, in which the glass strip is provided by a float process;

FIG. 2 is a schematic diagram of the process step of removal in top view in some embodiments;

FIG. 3 is a schematic diagram of the border removal in one working example in cross section;

FIG. 4 is a photograph of the working example shown in FIG. 3;

FIG. 5 is a schematic diagram of the border removal in a further working example in cross section;

FIG. 6 is a photograph of a glass plug;

FIG. 7 is a schematic diagram of the lehr in cross section;

FIG. 8 is a schematic diagram of a glass article in some embodiments; and

FIG. 9 is a schematic cross section through the embodiment shown in FIG. 8.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The invention relates to a process for producing a glass strip. In this process, a glass strip is first provided. The glass strip is obtained by a drawing process. The glass melt can be provided in different ways for the drawing process. According to a first variant, the glass strip is formed by drawing or lifting a glass melt on a float bath by floating. In a second variant, a glass melt is provided in a drawing tank with a nozzle and the glass strip is drawn from the nozzle. This can be effected, for example, by a down-draw process or by an up-draw process.

The glass strip has a useful region with largely homogeneous thickness and thickened edge regions. The edge regions have a greater thickness than the glass in the useful region and are also referred to as border region or border. The borders or edge regions extend along the edges of the glass strip in drawing direction. Drawing direction is the direction in which the glass strip is being drawn or transported.

The glass strip drawn off from the melt is deflected once at most. If the glass strip is provided by a float process, no deflection is necessary. In this embodiment, the glass strip is optionally transported horizontally in all process steps.

In the course of transportation, the glass strip cools further. The glass strip is optionally drawn through a lehr. In these process steps, transportation is optionally horizontal, i.e. orthogonal to gravity. In particular, the glass strip is not deflected again. This may be particularly advantageous in the provision of the glass by float methods. In some embodiments, the glass strip is lifted from a float bath and there is no deflection of the glass strip.

The drawn or lifted glass strip optionally has a thickness in the useful region of at least 0.1 mm, optionally of at least 0.3 mm, optionally of at least 0.32 mm and optionally of at least 0.33 mm. In some embodiments, the glass strip has a thickness in the useful region of at least 0.35 mm, more than 0.35 mm or even at least 0.4 mm. In some embodiments, the useful region of the glass strip has a thickness of not more than 1.3 mm or even not more than 0.8 mm.

In the first variant of the invention, the glass strip is lifted from a float bath, i.e. is a floated glass strip. In some embodiments, the glass strip is lifted or drawn from a float bath and has a thickness of at least 0.1 mm or at least 0.15 mm in the useful region. The glass strip in the useful region optionally has a thickness in the range of 0.1 to 1.3 mm.

In a second variant of the process, the glass strip is drawn from a drawing tank with a nozzle, optionally in a down-draw process or an up-draw process. The glass strip provided in this variant is a drawn glass. In this variant, a glass strip with a thickness of more than 0.3 mm is obtained. The glass optionally has a glass thickness of at least 0.32 mm, optionally of at least 0.33 mm. In some embodiments, the thickness in the useful region is at least 0.35 mm or even more than 0.35 mm, optionally at least 0.4 mm. The glass strips in the useful region optionally have a thickness of not more than 1.3 mm, optionally not more than 1.1 mm and optionally not more than 1 mm, optionally of at least 0.33 mm, in the useful region.

During the cooling of the glass strip, a laser beam is directed onto the glass strip with the aid of at least one laser. The laser irradiation takes place here at the time in the manufacturing process when the temperature of the glass is within a range between a viscosity of 10¹⁰ dPas and a viscosity of 10¹⁵ dPas, optionally between a viscosity of 10¹² dPas and a viscosity of 10¹³ dPas. Based on the cooling zone or apparatus, the point of incidence on the glass is at a position where the temperature of the glass is within a range between the upper cooling point at a viscosity of 10¹⁰ dPas and the lower cooling point at a viscosity of 10¹⁵ dPas.

The laser beam hits the glass strip perpendicularly to the glass surface, wherein the point of incidence of the laser beam is, or the point of incidences are, positioned in the region between the useful region and the edge region of the glass strip. Because of the relative movement between glass strip and laser beam, in particular by virtue of the further transportation of the glass strip in drawing direction, the laser beam thus traverses a line in drawing direction of the moving glass strip. This line forms the dividing line at which the useful region of the glass strip and the border region are spatially separated from one another. In some embodiments, the glass strip is moved horizontally while the laser beam traverses the glass. This may be particularly advantageous for glasses that are provided by float processes. In another embodiment, the glass strip is transported vertically during laser irradiation.

The wavelength of the laser is optionally selected such that it has a low penetration depth for the glass of the glass strip. The wavelength is optionally chosen such that the glass strip is heated directly by the beam only in the near-surface regions, in particular up to a depth of at most ⅓ of the glass thickness in the useful region, measured from the glass surface. In some embodiments, the glass strip is heated up to a depth of 0.1 mm, measured from the glass surface. In some embodiments, the laser beam is generated by means of a CO₂ laser.

At the point of incidence of the laser, the glass is photothermally processed locally. This photothermal process results in significant local heating of the glass in the region in question, and so there can be lowering of viscosity and/or ablation of the glass in the region of the point of incidence. For the purposes of the present disclosure, the term “photothermal process” means a process comprising melting of the glass and/or laser ablation thereof. Melting and laser ablation here may be of different intensity depending on the respective process parameters. Both processes in which the material is melted without ablation and processes in which laser ablation is predominant are covered by the term “photothermal process” according to the present disclosure.

In some embodiments, the photothermal process during laser irradiation greatly reduces the viscosity of the glass in the region of the point of incidence. The glass melts in this region over the entire thickness of the glass in the region of the point of incidence, such that a gap or an accumulation of gaps along the dividing line forms in the region of the dividing line and the useful region of the glass is at least partly separated from the thickened edge region along the line. The useful region and the thickened edge region are thus mechanically decoupled from one another. New edges are formed along the line.

The glass strip thus processed, i.e. the glass strip consisting of the useful region of the glass strip, is cooled further after the separation process.

In the process according to the invention, the glass at the time of laser irradiation is at a temperature close to the transformation point T_{g}. In the inventive temperature range between second cooling point and transformation point, the glass strip has a viscosity that counteracts the formation of mechanical stresses.

The laser irradiation optionally takes place in the lehr, especially in the hot region of the lehr. In some embodiments, the temperature in the lehr during laser irradiation is at least 580° C. This places high demands on the control and adjustability of the process. For instance, it is necessary to ensure that the optical structure of the laser is of highly thermally stable construction and that the individual components are not subjected to temperatures above their decomposition temperatures. In some embodiments, therefore, the laser is purged with an inert gas or purge gas and/or individual components, for example deflection mirrors, are actively cooled.

In this temperature region of the glass strip, it is possible to heat the glass locally in the region of the point of incidence of the laser to such an extent that the local viscosity is reduced to such an extent that a gap is formed. The gap extends across the entire glass thickness and is also referred to as a cut. The gap or cut can be formed both by melting the glass and by partial ablation processes. In this process, the glass is not only melted or removed in near-surface regions. The volume of the region in which the gap is formed arises here from the focal spot size of the incident laser beam, also referred to hereinafter as laser spot diameter, and the glass thickness. In the area of the point of incidence of the laser beam, the glass is thus cut.

The cut can be achieved in particular by a low viscosity and with utilization of the surface tension of the low-viscosity material. Surprisingly, after a cut has been formed, no further mechanical action on the glass strip is necessary to form a gap. Because of the surface tension of the glass, the glass contracts on both sides of the gap and forms new edges on both sides of the gap. The retracting material also forms a new border at the newly formed edge on the useful region. However, because of the comparatively small volume of molten glass, this new border is small and therefore behaves similarly to the glass in the useful region of the glass strip in the subsequent thermal processes. Unlike in dividing processes in which the glass is broken, the process according to the invention gives rise to an edge with high strength as a result of the melt rounding, which imparts high mechanical stability and strength to the glass strip in the subsequent transport and handling processes. In particular, the edge has been fire polished.

The newly formed edge here, in spite of melt rounding, has only slight melt edge thickening. This is achieved by keeping the melting volume small.

The edges are optionally formed across the entire irradiated region. However, there may be isolated instances of reclosure at the edges.

The above-described process can optionally remove both thickened edge regions or border regions of the glass strip. Accordingly, the glass strip has two points of incidence of two laser beams, and two new edges are formed on the useful region of the glass strip. The glass strip thus formed thus optionally no longer has any border regions, and the useful region of the glass strip is bounded by the two newly formed edges. The newly formed edges thus form the lateral edges of the glass strip, with the lateral edges running parallel or at least largely parallel to the transport direction of the glass strip.

In some embodiments, the glass strip producible by the process described has a rounded profile at the newly formed edge(s).

In embodiments in which the glass strip is transported horizontally and the laser beam is incident orthogonally thereto, the gap is formed parallel to gravity. As a result, the molten glass is also drawn out of the gap region by gravity. Corresponding embodiments are therefore also particularly suitable for production of relatively thick glass strips without the need for additional mechanical separation steps. It is thus possible in particular to produce glass strips with a glass thickness in the useful region of at least 0.1 mm, in particular from more than 0.3 mm up to a glass thickness of 1.3 mm. In some embodiments, the glass thickness in the useful region of the glass strip is in the range of more than 0.3 mm to 1.3 mm, optionally in the range of 0.32 to 1.1 mm. In particular, glass strips are also producible with a thickness in the useful region of 0.35 to 1 mm, and these can be used as cover glasses for example.

The apparatus is optionally designed such that the focal spot diameter or the laser spot diameter at the glass strip level is adjusted to the glass dimensions and the viscosity characteristics of the respective glass by variation of the focal position via adaptive mirror optics. The focal spot size of the laser beam can be used to adjust the gap width. The focal spot size or diameter of the laser spot is chosen here such that the gap width is large enough that retracting of the glass owing to the surface tension of the glass and possibly the effects of gravity on the molten glass prevent or at least reduce renewed contact of the glass in the edge regions and hence reclosure of the gap. At the same time, the focal spot size limits the gap width and hence the melt volume as well. This prevents excessive accumulation of molten glass volume and hence reformation of an elevated border.

Surprisingly, the use of a laser beam with a small focal spot size has been found to be particularly advantageous. This makes it possible to keep the gap width and hence the melt volume as well to a minimum in order to counteract thickening of the edges. Some advantageous laser spot diameters have been found to be less than 4 mm, less than 2.5 mm and optionally less than 1.5 mm. In some embodiments, the laser spot has a diameter of less than 1 mm or even less than 0.8 mm. In some embodiments, there is spatial and synchronized modulation of the laser power over time.

The incident laser power is optionally at least 750 W or even at least 900 W. Surprisingly, in combination with the small focal spot sizes, it is possible even with these comparatively moderate laser powers to achieve sufficiently high power densities with which even comparatively thick glasses can be cut. At the same time, the zone of thermal influence and hence the molten glass volume is kept small, and so there is also a reduction in edge thickening at the newly formed edges. One development provides for lateral and axial modulation of the laser focus. This may be particularly advantageous in the case of glass strips with a relatively large glass thickness in the useful region, since the modulation allows the cut to be kept open over the full width of the material and at the same time the total energy input to be kept as low as possible. In some embodiments, there is spatial and synchronized modulation of the laser power over time.

In the separation process, conduction of heat into the zone of thermal influence beyond the open gap can lead to viscous flow of the glass of the separation edge already formed. Because of the surface tension, the glass can be locally densified and hence lead to bridging across the gap. This results in an arrangement of reclosed gaps with high material thickness, akin to a string of beads. If the gap length is too small in relation to the length of the areas reclosed by bridge formation, also referred to as glass plug, the connecting material between the newly formed edges can result here in locally elevated stresses in the reclosed regions, which leads to rejection of the corresponding glass strip. However, the inventors have found that, surprisingly, lateral oscillation of the laser beam in transverse direction and/or in the direction of the feeding of the glass strip, i.e. in longitudinal direction, can assist uniform solidification of the molten glass and hence reduce the above-described bridge formation through reclosure. Isolated reclosures of the edges, which occur to a locally limited extent, do not prevent removal of the borders. Thus, even edges which have merely isolated reclosures, in particular in a random distribution, are covered by the term “separated edges”.

Relative movement in drawing direction of the glass strip is performed between the point of incidence of the laser and the glass strip. In some embodiments, the point of incidence of the laser is stationary and the relative movement corresponds to the tensile movement of the glass strip. The feed rate is optionally at least 1.5 m/min, optionally at least 2.5 m/min and optionally at least 4 m/min. A correspondingly high feed rate is accompanied by a small duration of action of the glass at the point of incidence of the laser. It is thus possible by virtue of the high feed rates detailed above to reduce conduction of heat to adjacent glass areas and hence keep the heat-affected zone small. This in turn can have an advantageous effect on melt thickening. In addition, it is thus possible to avoid the occurrence of thickened molten glass connections between the gaps. On the other hand, the feed rate must be sufficiently low to ensure complete cutting at the dividing line by virtue of the required conduction of heat. In some embodiments, the feed rate is therefore not more than 16 m/min, optionally not more than 10 m/min or even not more than 8 m/min. In some embodiments, the feed rate is at most 6 m/min, optionally 5.5 m/min. Alternatively or additionally, the feed rate is at least 1.5 m/min, optionally at least 4 m/min, optionally at least 4.5 m/min. In some embodiments, the feed rate on incidence of the laser is in the range of 1.5 to 6 m/min, optionally in the range of 4 to 5.5 m/min.

In some embodiments, the irradiated laser power is limited such that the proportion of ablation in the photothermal process is largely reduced and the glass is separated predominantly via the reduction in glass viscosity. A corresponding process can also be referred to as soft cutting. It has been found to be advantageous when an upper limit of <2 kW or even of at most 1.5 kW is chosen for the laser power. This has been found to be particularly advantageous for glasses with a thickness of up to 0.6 mm and/or at transportation speeds of the glass strip of up to 5 m/min.

The inventors have found that, in the separation process, complete separation can be achieved even in the case of glass strips with comparatively high glass thicknesses, with formation of barely thickened edges when laser spot diameter, feed rate, laser power and glass thickness are optimally adjusted to one another. In a further development, the relationship between laser power, laser spot diameter and feed rate is therefore as follows:
laser power/(laser spot diameter×glass thickness×feed rate)>6*10⁸ W*s/m³. A possibly advantageous ratio here has been found to be >1*10⁹ W*s/m³ or even>4*10⁹ W*s/m³. In some embodiments, the ratio is in the range of 6*10⁹ to 30*10⁹ W*s/m³.

In some embodiments, the intensity profile of the laser may take the form of a Gaussian distribution or similar steady distribution or of a top hat. Especially in the separation of glass strips with a useful thickness in the mm range, or a thickness of at least 1 mm, the use of a laser with top-hat-shaped intensity profile has been found to be advantageous. For instance, appropriate glass thicknesses require high peak power of the laser sources used. It was found here that, surprisingly, the glass material is not prone to edge damage (e.g. shell chips) or fracture as a result of the local, temporarily introduced stresses, since the glass body is already close to the transformation temperature T_{g} and hence the thermomechanical stresses are dissipated faster than expected at the temperature matched to the glass and are thus less critical than in the case of typical processes at room temperature.

In the case of lasers with a Gaussian intensity distribution, glass regions that lie in the edge regions of the beam profile are irradiated with an intensity which is not sufficient for a cut but merely reduces the viscosity of the glass to such an extent that it becomes locally free-flowing to a limited degree, or thermomechanical stresses are temporarily dissipated without contributing to the intended crack formation. Thus, the zone of thermal influence is distinctly larger than the gap width, and so there are local elevations in the melt edge in the useful region of the glass strip. Since, in contrast, a top-hat intensity profile, because of a steeper edge transition, has a much larger region in which the intensity is above the burning threshold for laser processing, the heat-affected zone can be distinctly reduced here compared to a Gaussian intensity distribution. Accordingly, it is possible to reduce unwanted effects such as elevation of the melting edge. In addition, the energy is utilized more efficiently in the top-hat intensity profile.

The above-described process steps of border removal by the method disclosed can also achieve fast cooling rates of the glass strip without excessive buildup of stress in the glass and without glass fracture. In some embodiments, the glass strip, after the borders have been removed, is cooled at a cooling rate of more than 100 K/min, optionally more than 200 K/min or even more than 300 K/min. The early separation of the borders in accordance with the invention and the use of high cooling rates thus achievable can also produce thin glass strips from glasses with a high tendency to crystallization by the process disclosed.

In a third variant of the process, a glass is therefore provided which is subject to the following condition:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 , optionally > 1.1$$

In this formula, α_{liq}=linear coefficient of thermal expansion above the glass transformation temperature of the glass, α₂₀₋₃₀₀=linear coefficient of thermal expansion of the glass at temperatures between 20° C. and 300° C., η_{liq}=liquidus viscosity of the glass,

$$\frac{d T}{d log ( η )} ( log ( η ) = 13 )$$

is the slope of the viscosity curve at the upper cooling point or at the temperature at which the glass has a viscosity η of 10¹³ dPas, and T₁₃ is the temperature at which the glass has a viscosity η of 10¹³ dPas. The slope of the viscosity curve at the upper cooling point is obtained here from the Vogler-Tamman-Fulcher coefficient, also known as the VTF coefficient.

Glasses that meet the above-mentioned condition show a high tendency to devitrification or crystallization, such that, in the drawing process, especially in the production of thin glasses, optionally with a thickness in the useful region of not more than 1.3 mm, cooling with high cooling rates is necessary. In some embodiments, glasses are provided that are subject to the following condition:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1.2 .$$

In some embodiments, the glass is a crystallizable glass for production of glass ceramics, also referred to hereinafter as green glass. In particular, the glass is a green glass for production of an LAS glass ceramic or an AS glass ceramic.

A further aspect of the invention relates to a glass strip producible by the above-described process, having two opposing surfaces and a homogeneous glass thickness extending between them. The glass strip with homogeneous thickness has a middle region with thickness d_{middle} and at least two edge regions with thickness d_{edge}. The edge regions form the edges of the glass strip. What is meant by a glass strip having homogeneous thickness is in particular a glass strip having an edge region having a thickness d_{edge} and a middle region having a thickness of the middle region d_{middle}, where the maximum thickness of the edge region d_{edge,max} is not more than 150% greater than the thickness of the middle region d_{middle}. Thus, the glass strip has in particular no thickened edge regions in the form of glass borders. The glass strip having homogeneous thickness can also be referred to as a border-free glass strip. The thickness of the glass strip is optionally not more than 1.3 mm, optionally not more than 0.8 mm.

In a first variant, the glass strip with homogeneous thickness is a float glass and optionally has, on one of the two surfaces, an elevated tin concentration compared to the composition of the bulk glass. The elevated tin concentration is attributable to the floating of the glass melt on a tin bath. In this embodiment, the glass strip is thus one produced by a float process. This glass strip with homogeneous thickness optionally has a thickness d_{middle} in the middle region of at least 0.1 mm, optionally of more than 0.3 mm, optionally in the range of at least 0.33 mm. The thickness d_{middle} in this embodiment is optionally in the range of 0.1 to 1.3 mm, optionally in the range of 0.1 to 0.8 mm.

In a second variant, the glass strip with homogeneous thickness is a drawn glass strip and/or has two fire-polished surfaces. In this embodiment, the glass strip having homogeneous thickness in the middle region optionally has a thickness d_{middle} of more than 0.3 mm, optionally of at least 0.32 mm, optionally of at least 0.33 mm, 0.35 mm or even at least 0.4 mm.

Alternatively or additionally, in this embodiment, the thickness of the middle region is not more than 1.3 mm, optionally not more than 1.1 mm, optionally not more than 1 mm. In some embodiments, the thickness d_{middle} is in the range of 0.32 mm to 1.3 mm, optionally in the range of 0.33 to 1.1 mm, optionally in the range of 0.4 to 1 mm.

Alternatively or additionally to the two abovementioned variants, the glass of the glass strip having homogeneous thickness in a third variant satisfies the following equation:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 , optionally > 1.1 , optionally > 1.2 .$$

In this formula, α_{liq}=linear coefficient of thermal expansion above the glass transformation temperature of the glass, α₂₀₋₃₀₀=linear coefficient of thermal expansion of the glass at temperatures between 20° C. and 300° C., η_{liq}=liquidus viscosity of the glass,

$$\frac{d T}{d log ( η )} ( log ( η ) = 13 ) = slope$$

of the viscosity curve at the upper cooling point or at the temperature at which the glass has a viscosity η of 10¹³ dPas, and T₁₃=temperature at which the glass has a viscosity η of 10¹³ dPas. The slope of the viscosity curve at the upper cooling point is obtained here from the Vogler-Tamman-Fulcher coefficient, also known as the VTF coefficient. In this embodiment, the glass optionally has a thickness of not more than 1.3 mm.

In a further development, the edge region has a thickness d_{edge}, where the maximum thickness of the edge region d_{edge,max} is optionally not more than 120%, optionally not more than 100%, greater than the thickness of the middle region d_{middle}. Because of the local shape, there is therefore little mass and hence little material to be cooled in the newly formed edge region. If the glass strip with homogeneous thickness is again guided through the cooling process around Tg, the permanent material stresses can additionally be minimized more quickly, since the volumes of the new edge pieces and of the useful region of the glass strip having homogeneous thickness, i.e. the border-free glass strip, are relatively small. Accordingly, the differences in the cooling process of the two regions are minimized, such that, compared to the original glass strip with border regions, distinctly higher cooling speeds can be achieved without causing stresses between the individual regions of the glass strip.

In a further aspect, the invention relates to a plate-shaped or disc-shaped glass article, in particular a flat glass. A plate-shaped or disc-shaped glass article is understood in particular to be a glass article having two opposing surfaces with lateral expansions in x and y direction and an intermediate edge face. The extent of the edge face in z direction corresponds to the glass thickness d_{glass}, where the lateral dimensions of the two surfaces in x and y direction are greater than the glass thickness. The glass article is particularly suitable for use as cover glass, for example as a cover glass in displays or for production thereof.

The glass article is optionally produced or producible by the above-described process or from the above-described glass strip. In some embodiments, the glass of the glass article is a drawn glass, in particular a drawn float glass. Since the surfaces of a drawn glass article in the course of manufacture do not come into contact with shaping tools in a formable state, for example with the surface of rollers, both surfaces of the glass article have low roughness. In some embodiments, at least one surface of the glass article has been fire polished. In contrast, for example, in the case of glass articles obtained by rolling processes, there may be at least one surface having a minimum roughness limited by the roughness and/or surface structure of the roller, provided that the corresponding surface is polished after the rolling process.

The properties of the glass of the glass article are subject to the following relationship:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 , optionally > 1.1 , optionally > 1.2 .$$

In this formula, α_{liq}=linear coefficient of thermal expansion above the glass transformation temperature of the glass, α₂₀₋₃₀₀=linear coefficient of thermal expansion of the glass at temperatures between 20° C. and 300° C., η_{liq}=liquidus viscosity of the glass,

$$\frac{d T}{d log ( η )} ( log ( η ) = 13 )$$

is the slope of the viscosity curve at the upper cooling point or at the temperature at which the glass has a viscosity η of 10¹³ dPas, and T13 is the temperature at which the glass has a viscosity η of 10¹³ dPas. The slope of the viscosity curve at the upper cooling point is obtained here from the Vogler-Tamman-Fulcher coefficient, also known as the VTF coefficient.

The glass article has a thickness d_{glass} in the range of 0.1 to 1.3 mm, optionally in the range of 0.1 to 0.8 mm and optionally in the range of 0.3 to 0.8 mm. In some embodiments, the smallest lateral dimension 1_{min(x, y)} in x and y direction of the glass article is >400 mm. Alternatively or additionally, in a further embodiment, the aspect ratio between the glass thickness d_{glass} and the smallest lateral dimension in x and y direction 1_{min(x, y)} is subject to the following condition:

$${l}_{min ( x , y )} / {d}_{g l a s s} > 500 , optionally > 1000 , optionally > 4000.$$

The glass article optionally has a maximum variance in thickness of the glass Δglass thickness=d_{glass(max)}−d_{glass (min)}(min)<0.1 mm. Alternatively or additionally, the glass thickness of the glass article varies by not more than 10%.

In some embodiments, the glass of the glass strip or the glass article is a borosilicate glass, for example a borofloat glass having a thickness of at least 0.25 mm or a low-loss borosilicate glass having a thickness of at least 0.1 mm. A low-loss borosilicate glass is especially a borosilicate glass that shows a very low dielectric loss at 10 GHz. For instance, dielectric loss at 10 GHz may be subject to the following condition: tan 6<0.0023.

In some embodiments, the glass of the glass article or of the glass strip is a borosilicate glass and contains the following components in % by weight:

| | |
|---|---|
| SiO₂ | 74 to 85 |
| B₂O₃ | 8 to 25 |
| Al₂O₃ | 0.5 to 4 |
| Li₂O | 0 to 1 |
| K₂O | 0.3 to 2 |
| MgO | 0 to 3 |
| CaO | 0 to 3 |

In some embodiments, a glass of the glass article or of the glass strip comprises the following components in % by weight based on oxide:

| | |
|---|---|
| SiO₂ | 57 to 69, optionally 59 to 69, optionally |
| | 61 to 69, where the upper limit |
| | may optionally be 67 in each case, |
| Al₂O₃ | 17 to 25, optionally 17 to 21, |
| B₂O₃ | 0 to 7, optionally 0 to 5, optionally 0 to 4.5, |
| Li₂O | 3 to 5.5, optionally 3.5 to 5.5, |
| Na₂O | 0.8 to 7, optionally 0.8 to 6, optionally 0.8 to 5.5, |

where optionally the total content of Al₂O₃ and SiO₂, based on the figure in % by weight, is between at least 75 and at most 92, optionally at most 90.

In some embodiments, a glass of the glass article or of the glass strip comprises the following components in % by weight based on oxide:

| | |
|---|---|
| SiO₂ | 57 to 69, optionally 59 to 69, optionally |
| | 61 to 69, where the upper limit |
| | may optionally be 67 in each case, |
| Al₂O₃ | 17 to 25, optionally 17 to 21, |
| B₂O₃ | 0 to 7, optionally 0 to 5, optionally 0 to 4.5, |
| Li₂O | 3 to 5.5, optionally 3.5 to 5.5, |
| Na₂O | 0.8 to 7, optionally 0.8 to 6, optionally 0.8 to 5.5, |
| K₂O | 0 to 1, optionally 0 to 0.8, optionally 0 to 0.7, |
| MgO | 0 to 2, optionally 0 to 1.5, optionally 0 to 1, |
| CaO | 0 to 4.5, |
| SrO | 0 to 2, optionally 0 to 1.5, optionally 0 to 1, |
| ZnO | 0 to 3, optionally 0 to 2, optionally 0 to 1.5, |
| P₂O₅ | 0 to 3, optionally 0 to 2, optionally 0 to 1.7, |
| ZrO₂ | 0 to 3, optionally 0 to 2, |

where impurities and/or refining agents and/or coloring components may also be present in amounts up to 2% by weight.

In some embodiments, a glass of the glass article or of the glass strip comprises the following components in % by weight based on oxide:

| | |
|---|---|
| SiO₂ | 62-72, optionally 65-70, |
| Al₂O₃ | 7-14, optionally 8-12, |
| B₂O₃ | 0.1-8.5, optionally <8.5 or ≤8, |
| | optionally 4-7, especially optionally ≥5, |
| | even optionally >5.5, |
| Li₂O | 5-12, optionally 7-10, |
| Na₂O | 0-2, optionally 0-1, optionally ≥0.1 and/or <1, |
| | optionally ≥0.3 and/or <0.8, |
| K₂O | 0-2, optionally 0-1 |

with 0.8<Li₂O/(Li₂O+K₂O+Na₂O)≤1

In some embodiments, a glass of the glass article or of the glass strip, especially a ceramizable glass, comprises the following components in % by weight based on oxide:

| | |
|---|---|
| SiO₂ | 55-75, optionally 62-72 |
| Al₂O₃ | 18-27, optionally 18-23 |
| Li₂O | 2.8-5, optionally 3-5 |
| Na₂O | 0-4, optionally 0-2 |
| K₂O | 0-4, optionally 0-2 |
| MgO | 0-8, optionally 0-4 |
| CaO | 0-4, optionally 0-2 |
| SrO | 0-4, optionally 0-2 |
| BaO | 0-4, optionally 0-2 |
| ZnO | 0-6, optionally 0-2 |
| TiO₂ | 0-4, optionally 0-3 |
| ZrO₂ | 0-5, optionally 1.2-4 |
| B₂O₃ | 0 to 2, optionally 0-0.1 |
| SnO₂ | 0-2, optionally 0.05-1.6 |

where the sum total of the components TiO₂ and ZrO₂ is optionally subject to the following condition:

0 < Σ (TiO₂ + ZrO₂) < 9.5%, optionally 1.2 < Σ (TiO₂ + ZrO₂) < 9.5%,

or the components SnO₂, ZrO₂ and TiO₂ are optionally subject to the following condition:

0 ≤ SnO₂/(ZrO₂ + TiO₂) <
0.8, optionally 0.01 ≤ SnO₂/(ZrO₂ + TiO₂) < 0.7.

In some embodiments, the glass of the glass article or of the glass strip is a crystallizable glass, in particular for production of a lithium aluminium silicate glass ceramic (LAS ceramic), and comprises the following components in % by weight based on oxide:

| | |
|---|---|
| SiO₂ | 65 to 71 |
| Al₂O₃ | 10 to 15 |
| B₂O₃ | 0 to 6 |
| Li₂O | 0 to 11 |
| Na₂O | 0.5 to 13 |
| K₂O | 0.1-3 |
| MgO | 0 to 7 |
| CaO | 0 to 3 |
| SrO | 0 to 0.5 |

The invention further relates to an apparatus for producing a glass strip having homogeneous thickness from a glass strip having a useful region and thickened edge regions with respect to the useful region. The edge regions are removed here. The apparatus comprises an apparatus for providing a glass strip, optionally a float tank, a lehr and transport apparatuses for transporting the glass strip from the apparatus for providing a glass strip through the lehr. In some embodiments, the glass strip is transported horizontally by the transport apparatuses. In particular, float glasses are transported horizontally. At least one laser beam is introduced into the lehr. In some embodiments, the laser beam is introduced by an optics designed in the form of a cantilever, where this laser arm extends laterally into the lehr. After exiting the laser, the laser beam is deflected orthogonally by a deflecting element, such that the laser beam hits the glass strip perpendicular or orthogonally to the transport direction or drawing direction. In an alternative embodiment, the laser beam is fed vertically through the lehr ceiling.

The point of incidence of the laser beam in relation to the glass strip is adjusted such that it lies on the interface between useful region and border region. The laser is positioned within the lehr in such a way that the point of incidence hits the glass strip at a position in the lehr where the temperature of the glass is within a range between the upper cooling point at a viscosity of 10¹⁰ dPas and the lower cooling point at a viscosity of 10¹⁵ dPas.

In some embodiments, the deflecting element is an imaging mirror. It has been found to be particularly advantageous when the apparatus has a cooling device for active cooling of the deflecting element or the mirror.

In some embodiments, the laser arm is designed to be pivotable or slidable. This allows the laser arm to be removed from the lehr. This enables good accessibility, for example the maintenance of the laser outside the hot area of the lehr. Alternatively or additionally, the laser arm includes an apparatus for purging with inert gas.

Exemplary advantageous transport apparatus has been found to be rollers and/or belts.

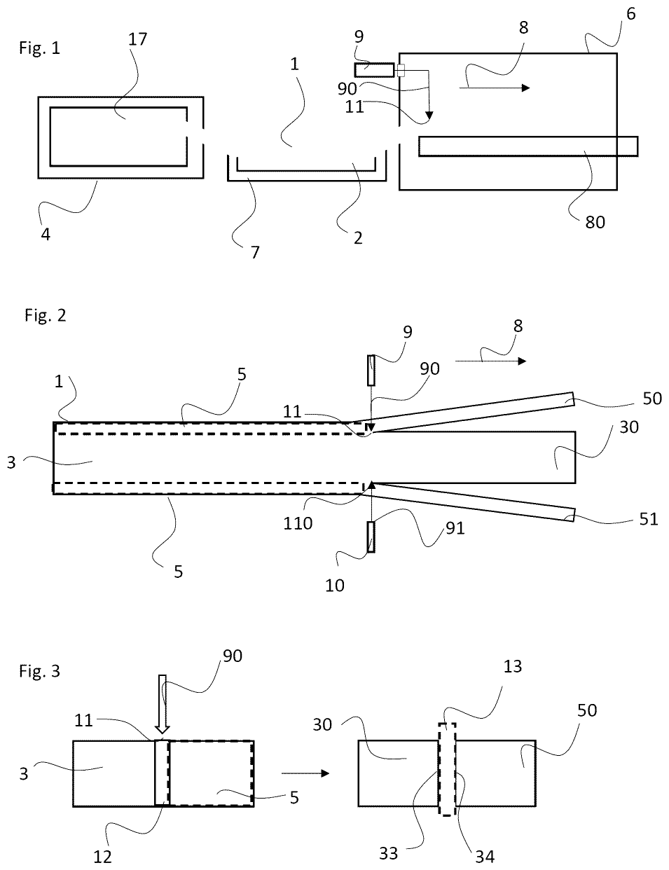

Referring now to the drawings, FIG. 1 shows a schematic diagram of a first variant of the process according to the invention. The molten glass 17 flows here from the tank to a float bath 2. The float bath 2 in this embodiment is a tin bath in the float tank 7. The glass strip 1 is formed on the float tank 2 and has a relatively thin useful region and thickened edge regions at each edge (not shown in FIG. 1). The glass strip 1 is lifted from the float bath 2 and transported into the lehr 6 in transport or drawing direction 8 by the transport apparatus 80. The glass strip 2 lifted from the float bath 2 is transported here horizontally in the transport direction 80 with a speed v_{feed}. As becomes clear from FIG. 1, the transportation of the glass strip 1 in this embodiment is horizontal and orthogonal to gravity. In particular, the glass strip 1 is transported horizontally throughout the process.

In the embodiment shown in FIG. 1, a laser beam 90, 91 hits the glass strip 1 in each case within the lehr 6. The point of incidences 11, 110 on the glass strip 1 are selected such that they lie in the interface region of the useful region to the thickened edge region or border region. Owing to the perspective view, FIG. 1 shows merely a laser 90 and the corresponding point of incidence 11.

The laser 9 is positioned such that the corresponding laser beam 90 hits the glass strip 1 at a position where the glass has a temperature within a range between the upper cooling point at a viscosity of 10¹⁰ dPas and the lower cooling point at a viscosity of 10¹⁵ dPas. The laser 9 is thus positioned in the hot region of the lehr. Depending on the respective construction of the apparatus, the laser 9 may also be positioned upstream of the lehr 6, provided that the glass strip 1 at this point has a temperature between an upper viscosity of 10¹¹ dPas and a lower viscosity of 10¹⁵ dPas.

Thus, by the process shown in FIG. 1, the thickened edge regions or border regions can be removed at an early stage of the process, such that the glass strip with homogeneous thickness 30 can subsequently be cooled quickly, i.e. with relatively high cooling rates. This enables the production of thin glass strips of float glass from glasses with a high tendency to crystallize, which were not previously producible by the float process. By the process according to the invention, on the other hand, it is also possible to provide, by the float process, thin glasses, in particular glasses with a thickness of not more than 1.3 mm that are subject to the following condition:

$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1.$$

Table 1 shows the coefficients of thermal expansion, the viscosity above the glass transformation temperature, the slope of the temperature-viscosity curve at the upper cooling point, and the index that can be obtained by equation (1) from three working examples. Glasses 1 to 3 are thin glasses with a thickness of at most 1.3 mm. Glasses 1 to 3 are ceramizable glasses for production of lithium aluminosilicate (LAS) glass ceramics. These green glasses therefore have high crystallizability, but should be in the form of glass in the manufacture of the thin glasses. Devitrification during the drawing process should therefore be avoided.

TABLE 1

| | α_{liq} [10⁻⁶ m * K] | α₂₀₋₃₀₀ [10⁻⁶ m * K] | η_{liq} [dPas] | T₁₃ [° C.] | $\frac{d T}{d log ( η )} ( log ( η ) = 13 )$ | FB |
|---|---|---|---|---|---|---|
| Glass 1 | 30.00 | 3.9 | 3.23 | 662.9 | 0.9805 | 2.106 |
| Glass 2 | 17.00 | 3.96 | 3.56 | 724.6 | 1.0803 | 1.679 |
| Glass 3 | 17.00 | 4.1 | 3.96 | 708.4 | 1.0562 | 1.3019 |

Glass 1 is a crystallizable green glass which can be converted to an LAS glass ceramic by subsequent ceramization processes. Glass 1 optionally has the following composition in % by weight:

| | |
|---|---|
| SiO₂ | 55-75, optionally 62-72 |
| Al₂O₃ | 18-27, optionally 18-23 |
| Li₂O | 2.8-5, optionally 3-5 |
| Na₂O | 0-4, optionally 0-2 |
| K₂O | 0-4, optionally 0-2 |
| MgO | 0-8, optionally 0-4 |
| CaO | 0-4, optionally 0-2 |
| SrO | 0-4, optionally 0-2 |
| BaO | 0-4, optionally 0-2 |
| ZnO | 0-6, optionally 0-2 |
| TiO₂ | 0-4, optionally 0-3 |
| ZrO₂ | 0-5, optionally 1.2-4 |
| B₂O₃ | 0 to 2, optionally 0-0.1 |
| SnO₂ | 0-2, optionally 0.05-1.6 |

where the sum total of the components TiO₂ and ZrO₂ is optionally subject to the following condition:

$$0 < \sum ( {TiO}_{2} + {ZrO}_{2} ) < 9.5 \% , optionally 1.2 < \sum ( {TiO}_{2} + {ZrO}_{2} ) < 9.5 \% ,$$

or the components SnO₂, ZrO₂ and TiO₂ are optionally subject to the following condition:

$$0 \leq {SnO}_{2} / ( {ZrO}_{2} + {TiO}_{2} ) < 0.8 , optionally 0.01 \leq {SnO}_{2} / ( {ZrO}_{2} + {TiO}_{2} ) < 0.7 .$$

Glass 2 is also a green glass for production of an LAS glass ceramic.

The crystallizability of this green glass which is required for production of glass ceramics is accompanied by a correspondingly high tendency of the glass to crystallization. This tendency to crystallize and the associated relatively high tendency to devitrification has been a barrier to the production of thin glass of glasses 1 and 2 in the float process. However, the inventive removal of the thickened edge regions or border regions and the rapid cooling thus enabled can counteract a devitrification process or premature crystallization during the production of the thin glasses in the process according to the invention.

Glass 3 is likewise a green glass for production of LAS glass ceramics and was only previously producible with glass thicknesses of about 4 mm by float processes. In the case of glass thicknesses of about 4 mm, the cooling rates required to suppress crystallization are still low enough to avoid the introduction of excessive mechanical stresses even without removing the borders. However, thinner glasses require higher cooling rates, and so production of floated thin glasses with relatively low thicknesses was not possible to date with glass 3. However, the removal of the borders and the higher cooling rates achievable thereby can prevent crystallization during the drawing process even in the case of thin glasses with glass 3. Thus, the process according to the invention, even for glass 3, can give floated thin glasses with very low thicknesses, in particular with thicknesses in the range of 0.1 to 1.3 mm.

FIG. 2 shows a schematic diagram of the process shown in FIG. 1 after lifting of the glass strip 1 from the float bath 2 in top view. Glass strip 1 has a middle useful region 3 and two thickened edge regions or border regions 5. After the glass strip has been transported into the lehr 6, a laser beam 90, 91 of the laser 9, 10 hits the glass strip 1 in each case at the interfaces between useful width 3 and the border regions 5. On incidence of the laser beams 90, 91, the glass strip 1 has a temperature below the upper cooling point and above the lower cooling point of the glass. At the point of incidence, the laser beam cuts through the glass strip 1. Since the glass strip 1 is moving simultaneously with the feed rate v_{feed} in transport direction 8, a gap is formed between the useful region 3 and the border regions 5. New edges are formed here on the useful region 3 and on the border regions 5. This affords the thickened glass strips 50, 51 and a new glass strip 30 with a new edge region 32. The edge region 32 here is only slightly thickened compared to the middle region of the glass strip 30. The glass strip having homogeneous thickness 30 continues to be fed through the lehr. Glass strips 50 and 51 are waste and can be remelted, for example. Several options are available for further treatment of glass strips 50, 51. For instance, the glass strips 50, 51, in some embodiments, just like the glass strip with homogeneous thickness 30, can continue to be transported continuously through the lehr 6. However, since the glass strips are attached to one another and the glass is rigid at temperatures below T_{g}, there is a risk of breakage in the handling of the removed glass strips 50, 51, which can affect the entire glass strip 1 and the separation zone. In another embodiment, the glass strips 50, 51 are therefore reduced in size to short sections that can be handled directly after separation from the glass strip with homogeneous thickness 30. A possibly advantageous method here has been found to be thermal blasting of the individual subsections of the glass strips 50, 51. For instance, this process exerts very little mechanical effect on the overall glass strip 1. Secondly, the process of thermal blasting on the glass strips 50, 51 can be implemented particularly easily since the glass is at relatively high temperatures, i.e. just below Tg. Accordingly, thermal shock is easy to achieve. In a further development, an initial defect is introduced into the glass strips 50, 51 before the thermal shock. A possibly advantageous method here has been found to be mechanical scoring of the glass. Because of the high glass temperatures, it is necessary here to use a thermally stable material, such as a highly heat-resistant metal.

FIG. 3 shows a schematic of the removal of the thickened edge region 5 from the glass strip 1 in cross section. The point of incidence 11 of the laser beam 90 lies in the interface between the useful region 3 and the thickened edge region 5. The hatched area 12 represents the glass volume which is melted by the laser beam 90. In the working example shown in FIG. 3, the glass strip has a thickness d of 0.6 mm in the useful region. The laser source used is a CO₂ laser, the incident power is 1000 W, and the focal spot size is 1 mm². A relatively high power is thus incident on a small area, and so the power density is correspondingly high. This allows a cut through the glass to form a gap 13. The glass strip 1 is thus separated into the glass strip with homogeneous thickness 30 and the glass strip 50 with formation of the edges 33 and 34. Because of the small focal spot size and the feed rate of 4.3 m/min experienced by the glass strip orthogonally to the incidence of the laser during the process, the gap width is kept small. In addition, a small focal spot size and relatively fast feed rate lead to a relatively small heat-affected zone. In particular, essentially only the glass regions in which the gap 13 is formed are melted.

In the working example shown in FIG. 3, the ratio of laser power, spot size and feed rate is adjusted so that the two glass regions 3 and 5 of the glass strip 1 are completely separated from one another by the gap 13. At the same time, the newly formed edges 33, 34 have an only slightly elevated melt edge.

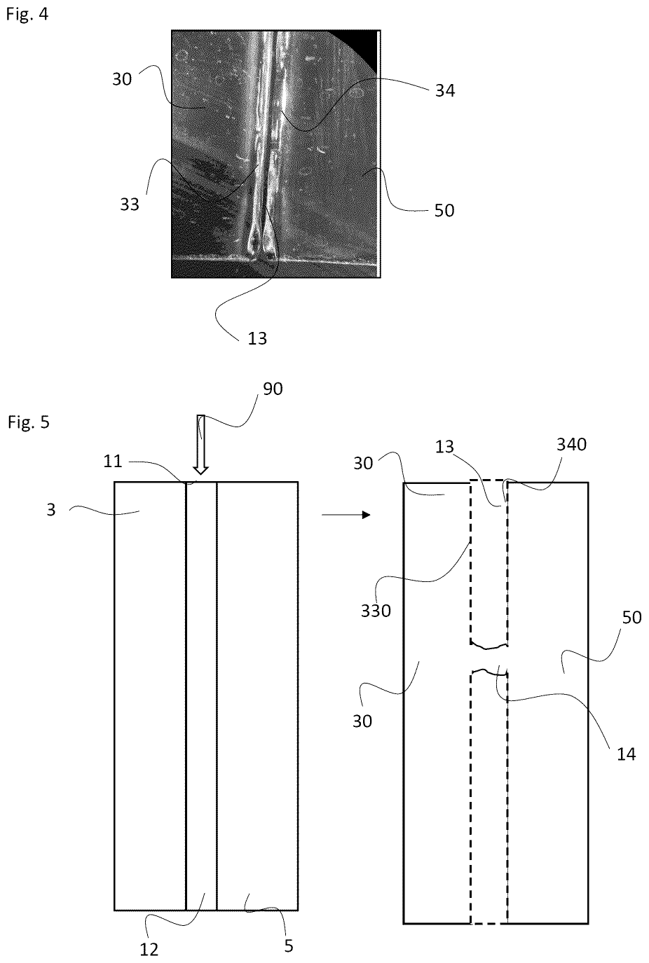

This is also clear with reference to FIG. 4, which shows a photograph of the two separated glass strips 30 and 50.

The ratio of laser power/(laser spot diameter×glass thickness×feed rate) in this working example is 23*10⁹ W*s/m³.

FIG. 5 shows, just like FIG. 3, the removal of the thickened edge region 5 from the glass strip 1 in cross section in a further embodiment. A larger focal spot size of 7 mm² was chosen here, and the melting volume 120 is correspondingly larger. The glass strip 1 was moved orthogonally to direction of incidence of the laser at a feed rate of 35 mm/s. As in the first working example, a gap 130 is first formed, forming the glass strip with homogeneous thickness 30 and the glass strip 50 with the edges 330 and 340. Since the melt volume is greater here and additionally does not solidify as rapidly as in the working example shown in FIG. 4 because of the slower feed rate, there may be isolated formation of regions having a glass plug 14 between the edges 330 and 340. Thus, there may be isolated instances of local reclosure of the gap 130. Since the formation of the glass plug 14 occurs only in an isolated manner, this does not significantly affect the removability of the borders 50, if at all. Edges 330, 340 that have isolated glass plugs 14 are therefore also referred to as separated edges in the context of the disclosure. It is thus possible for the glass plugs that occur in isolated instances to break spontaneously during the process, for example as a result of vibrations or movements of the glass edges 330, 340, and hence expose both glass edges 330, 340, without any further process step for this purpose.

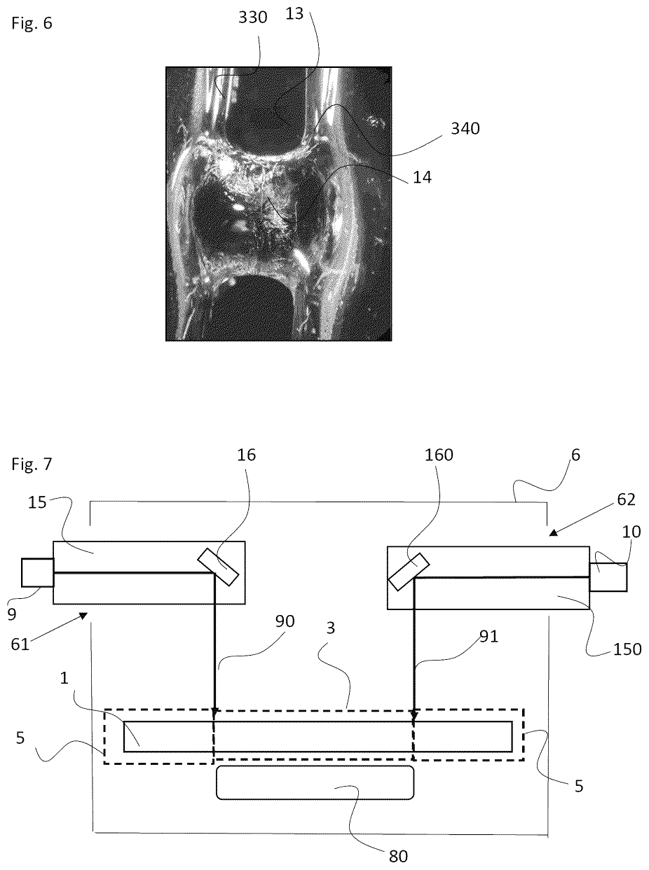

FIG. 6 shows a photograph of a detail of the example shown in FIG. 5. Between the glass edges 330, 340, a glass plug 14 has formed at the point shown in the gap 13. The detail shown in FIG. 6 is not representative here of the edges 330, 340, but instead shows a single site at which a glass plug 14 was formed. However, the edges 330, 340 are predominantly spaced apart from one another by the gap 13.

FIG. 7 shows a schematic diagram of the lehr 6 in some embodiments in cross section. In this embodiment, the glass strip is transported in the horizontal plane. The glass strip 1 with the thickened edge regions 5 and the useful region 3 is transported horizontally through the lehr 6 by the transport apparatus 80. The transport direction lies in the plane of the drawing. The laser arms 15, 150 of the lasers 9,10 project laterally into the lehr 6 through the lateral openings in the lehr 61, 62. The laser arms 15, 150 also each contain an imaging mirror 16, 160. The laser beam 90, 91 emitted by the laser 9, 10 at first exits parallel to the glass strip 1 and is respectively deflected downward by the mirrors 16, 160. At the points of incidence 11, 110, the laser beam 90, 91 hits the glass orthogonally to the direction of feeding of the glass strip. The point of incidence 11, 110 lies in the interface between thickened edge region 5 and the useful region 3 of the glass strip 1. The laser arms 15, 150 can be moved or pivoted out of the lehr 6 through the lateral openings 61, 62 in the lehr 6. In some embodiments, the mirrors 16, 160 are actively cooled. In addition, the laser arms 15, 150 may include an apparatus for purging with a purge gas (not shown in FIG. 7), and so the laser arms 15, 150 are closed off from the atmosphere in the lehr 6.

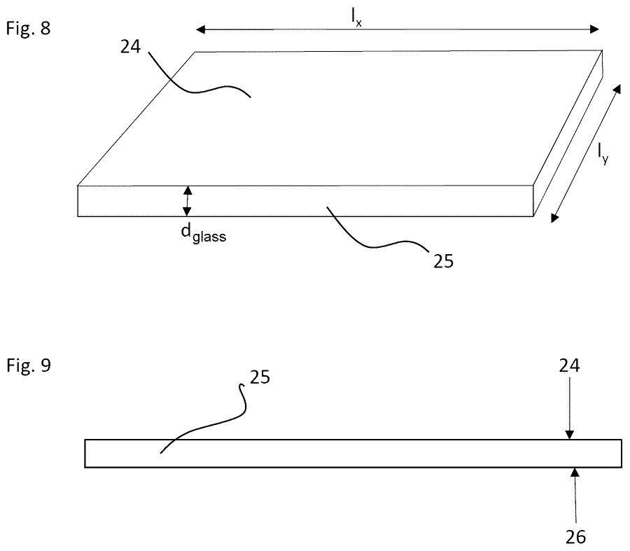

FIG. 8 shows a schematic diagram of a glass article according to the invention in one working example in top view; FIG. 9 shows a schematic cross section through this glass article. The diagrams shown in FIGS. 8 and 9 are not true to scale, in particular not with regard to the individual dimensions of the glass article. The glass article has two opposite lateral faces 24, 26 and a circumferential edge face 24. The lateral faces 24, 26 have lateral dimensions 1ₓ, 1_{y} in x and y direction. The lateral dimension of the edge face 25 in z direction corresponds to the glass thickness d_{glass}. The working example shown in FIGS. 8 and 9 has a minimum lateral dimension 1ₓ, 1_{y} of the lateral faces 24, 26 in x and y direction of >400 mm and a glass thickness d_{glass}<0.8 mm. The glass article in this working example was produced by the process according to the invention and is a float glass. The glass was lifted here from a tin bath, with the lateral face 26 in contact with the tin bath. The near-surface regions of the lateral face 26 therefore have an elevated tin concentration compared to the bulk glass.

The glass of the glass article corresponds to the glass 3 from Table 1.

The glass article has been fire polished on the lateral faces 24.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 glass strip
2 float bath
3 useful region of the glass strip 1
4 tank
5 thickened edge region or border of the glass strip 1
6 lehr
7 float tank
8 transport or drawing direction
9, 10 laser
11, 110 point of incidence
12, 120 melt volume
13, 130 gap
14, 140, 141 glass plug
15, 150 laser arm
16, 160 mirror
17 molten glass
24,26 lateral faces of 27
25 edge face of 27
27 glass article
30 glass strip having homogeneous thickness
31 middle region of 30
32 edge region of 30
33, 34, 330, 340 fire-polished edge
50, 51 glass strip
61, 62 lateral opening in the lehr
80 transport direction
90, 91 laser beam

What is claimed is:

1. A process for producing a glass strip with homogeneous glass thickness, the process comprising:
obtaining a glass strip from a melt by a drawing process, wherein the glass strip has a useful region and thickened edge regions with respect to the useful region which extend along edges of the glass strip in a drawing direction;
cooling the glass strip, wherein during the cooling, a laser beam is directed at the glass strip by at least one laser such that it traverses a line in the drawing direction of the horizontally moving glass strip owing to a movement of the glass strip, wherein a point of incidence of the laser beam is chosen such that the line forms an envisaged dividing line between the useful region and the thickened edge region and the point of incidence on the glass is at a position where a temperature of the glass is within a range between an upper viscosity of 10¹⁰ dPas and a lower viscosity of 10¹⁵ dPas, wherein the laser beam photothermally processes the glass strip in an irradiated region such that a gap is formed along the line between the useful region and the thickened edge region and a glass strip with a homogeneous glass thickness and a new edge parallel to the drawing direction and a separated thickened edge region is obtained, and wherein the cooling of the glass strip with homogeneous thickness is continued after separation;
wherein the useful region of the glass strip has a thickness of more than 0.3 mm, or
wherein the useful region of the glass strip has a thickness of more than 0.1 mm and the drawing process comprises a float process and the glass strip is lifted from a float bath, or
wherein the glass strip is subject to the following condition:
$$F B = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1$$
where α_{liq}=a linear coefficient of thermal expansion above a glass transformation temperature of the glass, α₂₀₋₃₀₀=a linear coefficient of thermal expansion of the glass at temperatures between 20° C. and 300° C., η_{liq}=a liquidus viscosity of the glass,
$$\frac{d T}{d log ( η )} ( log ( η ) = 13 ) = a$$
slope of a viscosity curve at an upper cooling point or at a temperature at which the glass has a viscosity η of 10¹³ dPas, and T₁₃=a temperature at which the glass has a viscosity η of 10¹³ dPas.

2. The process of claim 1, wherein at least one of the following is satisfied:
the laser beam has a wavelength at which the glass of the glass strip is heated by the laser beam only in a near-surface region;
the laser beam is produced by a CO₂ laser; or
the glass strip is transported horizontally in the course of cooling and/or during laser irradiation.

3. The process of claim 1, wherein the laser beam has a laser spot diameter of less than 4 mm².

4. The process of claim 1, wherein a relative movement in the drawing direction of the glass strip is performed between the glass strip and the point of incidence of the at least one laser, and wherein this relative movement has a feed rate of at least 1.5 m/min and/or at most 6 m/min.

5. The process of claim 1, wherein the laser beam has a power of at least 750 W.

6. The process of claim 1, wherein a ratio of a laser power, a laser spot diameter, a glass thickness, and a feed rate is subject to the following condition:
$$laser power / ( laser spot diameter \times glass thickness \times feed rate ) > 7 * {10}^{8} W * s / {m}^{3} .$$

7. The process of claim 1, wherein the glass strip is provided by drawing on a float bath by floating.

8. The process of claim 1, wherein the glass strip in the useful region has a thickness of at least 0.32 mm and/or a thickness in a range of 0.33 to 1.3 mm.

9. The process of claim 1, wherein the process is conducted in a lehr.

10. The process of claim 1, wherein the new edge has been fire polished.

11. A glass strip having homogeneous thickness, produced by the process of claim 1,
wherein the glass strip having homogeneous thickness has a middle region and at least one edge region, wherein the at least one edge region forms the edge of the glass strip having homogeneous thickness, wherein the glass strip having homogeneous thickness in the middle region has a thickness d_{middle} of more than 0.3 mm and wherein the at least one edge region has a thickness d_{edge}, where d_{edge} has a maximum thickness d_{edge,max}, which is not more than 120% greater than the thickness d_{middle} in the middle region of the glass strip having homogeneous thickness.

12. The glass strip having homogeneous thickness of claim 11, wherein the at least one edge region has been rounded such that the edge has a rounded profile and/or the edge has been fire polished.

13. The glass strip having homogeneous thickness of claim 11, wherein the glass strip having homogeneous thickness has a tin concentration which is greater than a tin concentration of the glass in bulk material in near-surface regions of one lateral face.

14. The glass strip having homogeneous thickness of claim 11, wherein the glass of the glass strip having homogeneous thickness is subject to the following condition:
$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 ,$$
where α_{liq}=a linear coefficient of thermal expansion above a glass transformation temperature of the glass, α₂₀₋₃₀₀=a linear coefficient of thermal expansion of the glass at temperatures between 20° C. and 300° C., η_{liq}=a liquidus viscosity of the glass,
$$\frac{d T}{d log ( η )} ( log ( η ) = 13 ) = a$$
slope of a viscosity curve at an upper cooling point or at a temperature at which the glass has a viscosity η of 10¹³ dPas, and T₁₃=a temperature at which the glass has a viscosity η of 10¹³ dPas.

15. A glass article in the form of a flat glass, comprising two opposite sides and a glass thickness d_{glass}, wherein the glass thickness d_{glass} is at most 1.3 mm and a glass of the glass article is subject to the following condition:
$$FB = \sqrt{\frac{{α}_{l i q} + {α}_{20 - 300}}{30 \cdot {10}^{- 6} / K}} \cdot {( \frac{4.6}{log ( {η}_{l i q} / dPas )} )}^{2} \cdot \frac{\frac{d T}{d log ( η )} ( log ( η / dPas ) = 13 )}{- 28 ° C .} \cdot \frac{{T}_{13}}{650 ° C .} > 1 ;$$
wherein α_{liq}=a linear coefficient of thermal expansion above a glass transformation temperature of the glass, α₂₀₋₃₀₀=a linear coefficient of thermal expansion of the glass at temperatures between 20° C. and 300° C., η_{liq}=a liquidus viscosity of the glass,
$$\frac{d T}{d log ( η )} ( log ( η ) = 13 ) = a$$
slope of a viscosity curve at an upper cooling point or at a temperature at which the glass has a viscosity η of 10¹³ dPas, and T₁₃=a temperature at which the glass has a viscosity η of 10¹³ dPas.

16. The glass article of claim 15, wherein the glass article is a drawn glass.

17. The glass article of claim 15, wherein the glass article is a float glass.

18. The glass article of claim 15, wherein lateral dimensions of lateral faces of the glass article are >400 mm and/or a ratio between a smallest lateral dimension of the lateral faces 1_{min(x,y)} and the glass thickness d_{glass} is subject to the following condition:
$${l}_{min ( x , y )} / {d}_{glass} > 500.$$

19. The glass article of claim 15, wherein the glass comprises the following components in % by weight based on oxide:

| | |
|---|---|
| SiO₂ | 57 to 69; |
| Al₂O₃ | 17 to 25; |
| B₂O₃ | 0 to 7; |
| Li₂O | 3 to 5.5; and |
| Na₂O | 0.8 to 7. |

20. The glass article of claim 15, wherein the glass comprises the following components in % by weight based on oxide:

| | |
|---|---|
| SiO₂ | 57 to 69; |
| Al₂O₃ | 17 to 25; |
| B₂O₃ | 0 to 7; |
| Li₂O | 3 to 5.5; |
| Na₂O | 0.8 to 7; |
| K₂O | 0 to 1; |
| MgO | 0 to 2; |
| CaO | 0 to 4.5; |
| SrO | 0 to 2; |
| ZnO | 0 to 3; |
| P₂O₅ | 0 to 3; and |
| ZrO₂ | 0 to 3. |

21. The glass article of claim 15, wherein the glass comprises the following components in % by weight based on oxide:

| | |
|---|---|
| SiO₂ | 62-72; |
| Al₂O₃ | 7-14; |
| B₂O₃ | 0.1-8.5; |
| Li₂O | 5-12; |
| Na₂O | 0-2; |
| K₂O | 0-2; |

wherein 0.8<Li₂O/(Li₂O+K₂O+Na₂O)<1

22. The glass article of claim 15, wherein the glass comprises the following components in % by weight based on oxide:

| | |
|---|---|
| SiO₂ | 55-75; |
| Al₂O₃ | 18-27; |
| Li₂O | 2.8-5; |
| Na₂O | 0-4; |
| K₂O | 0-4; |
| MgO | 0-8: |
| CaO | 0-4; |
| SrO | 0-4; |
| BaO | 0-4; |
| ZnO | 0-6; |
| TiO₂ | 0-4; |
| ZrO₂ | 0-5; |
| B₂O₃ | 0 to 2; and |
| SnO₂ | 0-2. |

23. An apparatus for producing a glass strip having homogeneous thickness from a glass strip, wherein the glass strip has a useful region and thickened edge regions with respect to the useful region, by removing the edge regions, the apparatus comprising:
a drawing apparatus for producing a glass strip from a glass melt;
a lehr;
transport apparatuses for transporting the glass strip from the drawing apparatus into the lehr; and
a laser arranged in the lehr such that a laser beam produced by the laser hits the glass strip perpendicular to a transport direction, wherein a point of incidence of the laser is adjusted such that it is on the glass strip in an interface between the useful region and a border region.
